(19) United States
(12) Patent Application Publication
(10) Pub. No.: US 2003/0189551 A1
(43) Pub. Date: Oct. 9, 2003

(54) System and method for identifying functions invoked by function keys on a keyboard

(76) Inventor: Jesse Dale Olsen, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/117,481

(22) Filed: Apr. 4, 2002

(51) Int. Cl. G09G 5/00

(52) U.S. Cl. 345/168

(57) ABSTRACT

This system and method allow identification of functions invoked by function keys on a keyboard. The keyboard preferably includes a plurality of function keys, and at least one display device. The display device is configured to display icons that correspond to the function keys and give an indication of a function invoked by each function key. A keyboard driver may transmit icon data to said keyboard.

### FIELD OF THE INVENTION

The present invention relates to the field of computer systems. More particularly, the present invention relates to a system and method for identifying functions invoked by function keys on a keyboard.

### BACKGROUND OF THE INVENTION

Computers typically run a variety of applications that allow users to perform tasks such as word processing, accounting, graphic design, etc. An application typically creates a document or file in response to commands from the user. The file created will contain the input of the user to that application. The input from the user may be, for example, typed text, numerical data, the composition of a graphic design, etc. The user's work may then be printed, transmitted or stored for future use by the application.

A user typically interacts with the applications running on his or her computer using, for example, a keyboard and/or a mouse, trackball or trackpad. With a keyboard, the user can type text and numerical data into an application. With the mouse the user can select on-screen buttons or operate user interface devices provided by the application to control application.

In some instances, a command or a function that can be initiated with the mouse can be initiated by pressing a sequence of keys on the keyboard. Alternatively, some functions may only be accessible through pressing keys on the keyboard, rather than using the mouse. Most current keyboards include a number of function keys that are specifically intended to allow a user to quickly enter commands or call functions of an application without using a mouse.

On standard keyboards, there are typically twelve function keys labeled F1 through F12 and arranged in three groups of four keys each. The function keys are dynamic ion they call may change depending on the application running on the computer. For example, if a word processing application is running on the computer, pressing the “F1” key may initiate the application's on-line help features. While, if the computer is running a graphic design application, pressing the “F1” key may open a new file.

The presence of the function keys allows application designers to assign various functions to each of the function keys. This gives the user a shortcut to activating those functions, if the user knows which function key has been assigned to a particular function. To complicate this, additional functions may typically be called by pressing the function keys in combination with other keys such as the control (CTRL), alternate (ALT) or shift keys.

If the user runs a variety of applications on the computer, it may be extremely difficult for the user to remember which function key, or sequence of keys including a function key, can be used to initiate a particular function of the application. Consequently, the user may simply discontinue or avoid using the function keys. It may well be that learning and using the function keys would increase the user's efficiency and ability to operate the application. However, the effort required to learn the function keys and key combinations is perceived as too burdensome to warrant the time. Using the mouse to activate a function may take more time, but the user will typically be guided by text or graphic icons that indicate what functions are available to be activated with a click of the mouse.

### SUMMARY OF THE INVENTION

The present invention may be embodied in many different systems, methods, products, etc. For example, the present invention may be embodied in a system for identifying functions invoked by function keys on a keyboard. Such a system preferably includes a keyboard having a number of function keys, and at least one display device. The display device is configured to display icons that correspond to the function keys and give an indication of a function invoked by each function key. The system may also include a keyboard driver for transmitting icon data to the keyboard.

The present invention may also be embodied in a bundle of software stored on a data storage medium. The bundle of software may include, for example, an application and a keyboard icon file containing icons corresponding to functions assigned to function keys of a keyboard by the application.

The present invention may also be embodied in a method for identifying functions invoked by function keys on a keyboard by displaying icons on a display device on the keyboard, the icons being associated respectively with the function keys and giving an indication of a function invoked by each respective function key.

### BRIEF DESCRIPTION OF THE DRAWINGS

The accompanying drawings illustrate preferred embodiments of the present invention and are a part of the specification. Together with the following description, the drawings demonstrate and explain the principles of the present invention. The illustrated embodiments are examples of the present invention and do not limit the scope of the invention.

FIG. 1 illustrates a basic computer system with which embodiments of the present invention may be practiced.

FIGS. 2a-c illustrates various embodiments of a keyboard for a computer system according to principles of the present invention.

FIG. 3 illustrates a keyboard and central processing unit of a computer system that implements an embodiment of the present invention.

FIG. 4 is a flowchart illustrating a method according to principles of the present invention.

FIG. 5 illustrates a bundled application and keyboard icon file according to principles of the present invention.

Throughout the drawings, identical reference numbers designate identical elements.

### DETAILED DESCRIPTION OF THE PREFERRED EMBODIMENTS

The present invention enhances the ability of a computer user to make use of the function keys that dynamically call particular functions depending on the application currently active on the computer. Under principles of the present invention, small display devices, for example, liquid crystal display devices, are incorporated into the keyboard. Preferably, a display device is located above each function key. A keyboard driver can then display a graphic or textual icon on each of the small display devices to give an indication of the function that may be called by pressing the adjacent function key. In this way, a user can make use of the function keys without being required to memorize all the various functions called by the function keys for each of the applications that may be run on the computer system.

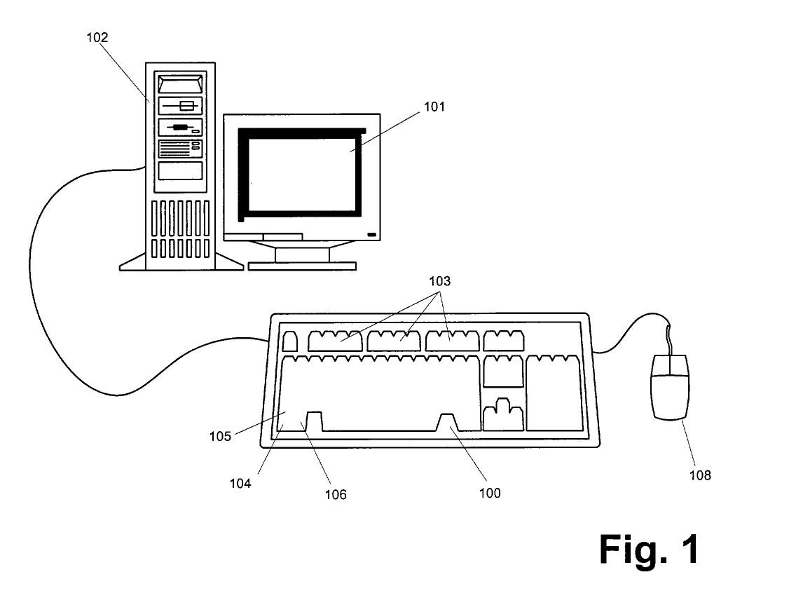

FIG. 1 illustrates a typically computer system with which an embodiment of the present invention may be practiced. As shown in FIG. 1, the computer system includes a central processing unit (CPU) (102). The CPU (102) typically stores and executes the applications installed on the computer system. A monitor (101) is connected to the CPU (102) and used by the CPU (102) to display the graphic user interface of executing applications. The monitor (101) is also used to echo or display the input of the user to the application.

A keyboard (100) and mouse (108) are also typically connected to the CPU (102). The user operates the keyboard (100) and mouse (108) to control the application or applications running on the CPU (102) and to provide input data to those applications.

The keyboard (100) preferably includes various alphanumeric keys (107) with which a user can produce typed text or numerical entries. Additionally, the keyboard (100) preferably incorporates a number of function keys (103). The function keys (103) may number twelve and be labeled F1 to F12. The function keys (103) may be continuously disposed along the top row of the keyboard (100) or may be arranged in three groups of four keys per group as shown in FIG. 1.

As indicated above, the purpose of the function keys (103) is to call functions of the currently active application running on the CPU (102). An application designer can assign the functions that will be called by the various function keys (103) when that application is active. Unfortunately, this has in the past required the user to memorize which function is called by which function key for each application frequently used. Otherwise, the function keys have been of little or no use to the user.

The keyboard (100) may also include a shift key (105), a control (CTRL) key (104) and an alternative (ALT) key (106). These keys (104-106), when pressed in combination with the function keys (103), call other functions of the active application that are not called by pressing the function keys (103) alone. This greatly increases the number of functions that can be quickly called by simply pressing keyboard keys. However, it also greatly increases the burden on the user to know which keystroke combination will invoke the desired function.

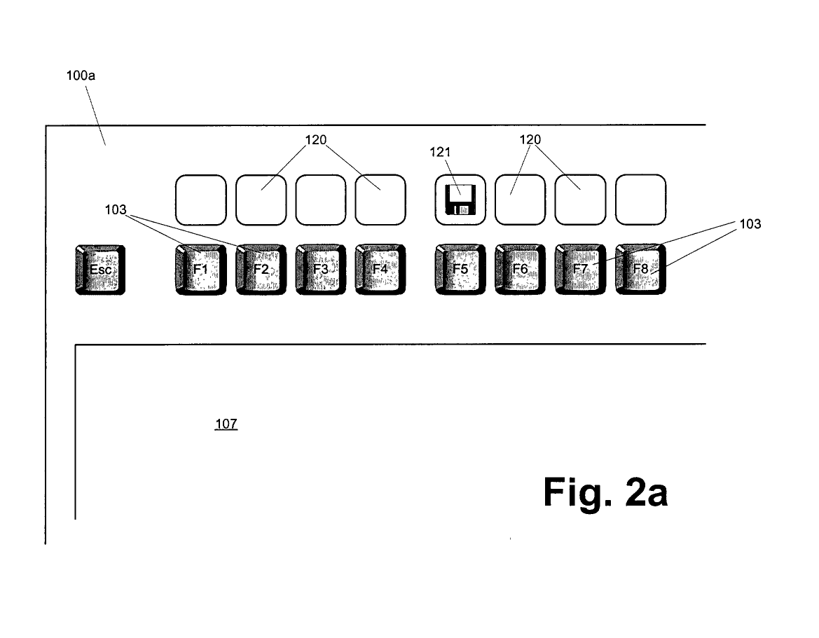

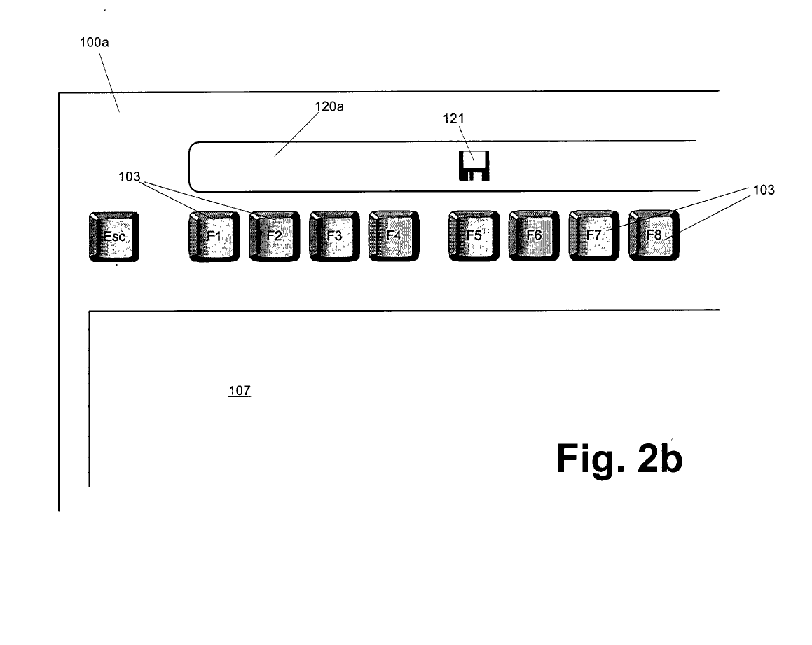

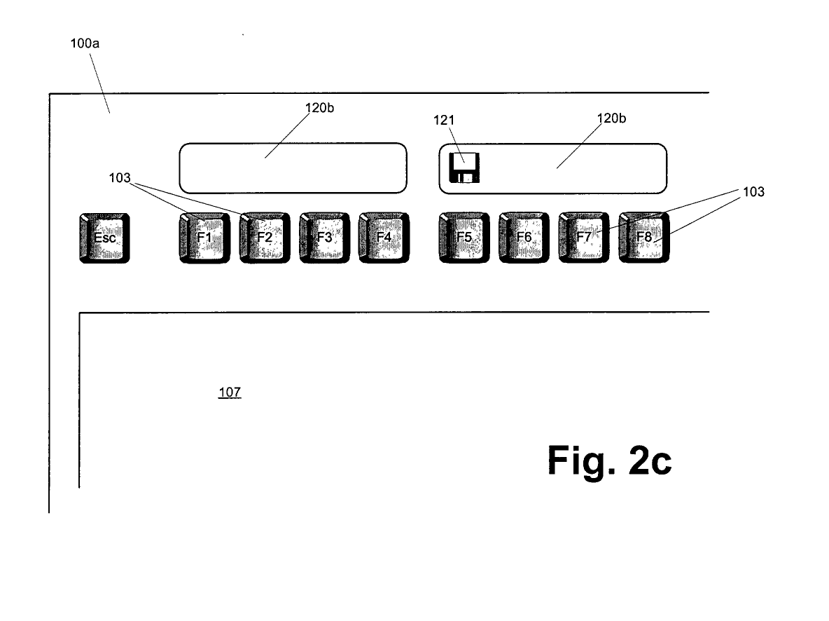

The present invention addresses these problems through novel modifications to the keyboard (100a). FIG. 2 illustrates a portion of one possible embodiment of an improved keyboard (100a) according to principles of the present invention.

As shown in FIG. 2, the keyboard (100a) provides function keys (103). As before, the function keys (103) may be continuously disposed along the top row of the keyboard (100) or may be arranged in three groups of four keys per group as shown in FIG. 2. The function keys (103) may be arranged anywhere on the keyboard under the principles of the present invention. The keyboard (100a) also includes the standard alphanumeric and punctuation keys (107), as well as the shift key (105; FIG. 1), the control (CTRL) key (104; FIG. 1) and the alternative (ALT) key (106; FIG. 1).

Additionally, the keyboard (100a) includes a number of small display devices (120). These display devices (120) may be, for example, liquid crystal display devices. Preferably, one such display device (120) is associated with each function key (103). Preferably, this association is created, as shown in FIG. 2, by disposing a display device (120) immediately above each function key (103). The function key (103) is then associated with the display device (120) aligned above that function key (103). Other configurations and conventions for associating a display device (120) with a function key (103) are within the scope of the present invention.

The display devices (120) are used to display icons, graphic or textual, that give an indication of the function called by pressing the associated function key (103). In this way, the user need not memorize which function key (103) calls which function. Rather, the user can rely on the icons displayed on the display device (120).

For example, as shown in FIG. 2, an icon (121) is illustrated on the display device (120) above the F5 function key (103). This icon (121) is of a floppy disk indicating that by pressing the F5 key, the user can initiate a save of the file being worked with through the then-active application.

In most operating systems, for example, Windows®, only a single application is active at any one time. There may be a number of applications running in a number of windows, but only one is the active application. Typically the mouse is used to switch the focus from one application to another, i.e., to activate another application. The active application is the application that will receive, for example, typed text or numerical input when made from the keyboard.

As the active application changes, the functions called by the function keys (103) may also change. Consequently, a different set of icons may be displayed on the display devices (120) depending on the active application running on the computer system. Additionally, if no application is running, or if all applications are minimized and the desktop active, the function keys may invoke functions defined by the operating system. Consequently, a set of icons specific to the operating system may be displayed if no application is running or if the desktop is active.

FIG. 2b illustrates an alternative embodiment of a keyboard according to principles of the present invention. As illustrated in FIG. 2b, there need not be a separate display device for each function key. Rather, a single display device (120a) may run alongside the function keys (103) and display appropriate icons (e.g., 121) that are associated with, e.g., adjacent to, corresponding function keys (103).

FIG. 2c illustrates a third alternative embodiment of a keyboard according to principles of the present invention. As illustrated in FIG. 2c, there may be a separate display device (120b) for each grouping of function keys (103). Again, icons (e.g., 121) are displayed in association with, e.g., adjacent to, corresponding function keys (103).

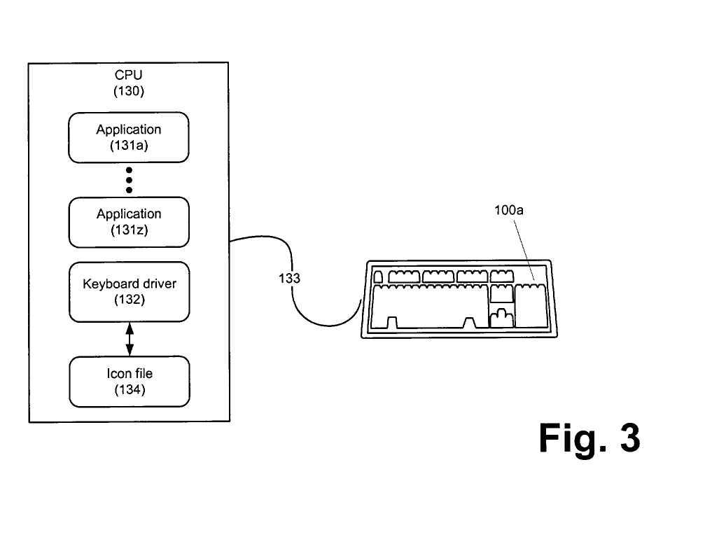

FIG. 3 illustrates a keyboard and central processing unit of a computer system that implements an embodiment of the present invention. As shown in FIG. 3, the keyboard (100a) that includes miniature display devices (120: FIG. 2) associated with the function keys (103; FIG. 2) is connected (133) to the CPU (130) of a computer system. Preferably, the connection between the keyboard (100a) and the CPU (130) is a Universal Serial Bus (USB) (133).

The CPU (130) maybe executing a number of applications (131a-131z). As described above, only one of the applications (e.g., 131a) will be the active application at any one time.

In addition to the applications (131a-131z), the CPU (130) is preferably also running a keyboard driver (132). The keyboard driver (132) may be a component of the operating system or may be a separate application that runs in the background on the CPU (130).

Depending on the active application, the keyboard driver (132) may access a file of icons (134) that correspond to the functions assigned to the function keys by that active application. The keyboard driver (132) then transmits the icon data over the connection (133) to the keyboard (100a). The display devices (120; FIG. 2) on the keyboard (100a) then display the appropriate icons in association with the various function keys.

As noted above, there are other keys that may be pressed in combination with the function keys to call a broader range of functions. As used herein and in the appended claims, the term “alternative function keys” is used to describe that group of keys that may be pressed in combination with a function key to increase the number of functions invoked ed by the set of function keys. The shift key (105; FIG. 1), the control (CTRL) key (104; FIG. 1) and the alternative (ALT) key (106; FIG. 1) are commonly used as alternative function keys.

For example, pressing the F1 function key may invoke a first function of the application. Pressing the F1 function key while also holding down the CTRL key (104; FIG. 1) may invoke a second function of the application. Pressing the F1 function key while also holding down both the CTRL key (104; FIG. 1) and the ALT key (106; FIG. 1) may invoke a third function of the active application.

Consequently, when, for example, the CTRL key (104; FIG. 1) is pressed and held, the keyboard driver (132) will note the signal from the CTRL key (104; FIG. 1) and access a second set of icons that represent the functions that will be invoked by the function keys if one of the function keys is pressed while the CTRL key (104; FIG. 1) is also held down. This second set of icons is sent to the keyboard (100a) for display by the display devices (120; FIG. 2). Similarly, if the CTRL key (104; FIG. 1) and the ALT key (106; FIG. 1) are both held down, the keyboard driver (132) will access and send a third set of icon data to the keyboard (100a) that allows the display devices (120; FIG. 2) to display icons representing the functions that will be invoked by the function keys if one of the function keys is pressed while the CTRL (104; FIG. 1) and ALT (106; FIG. 1) keys are held down.

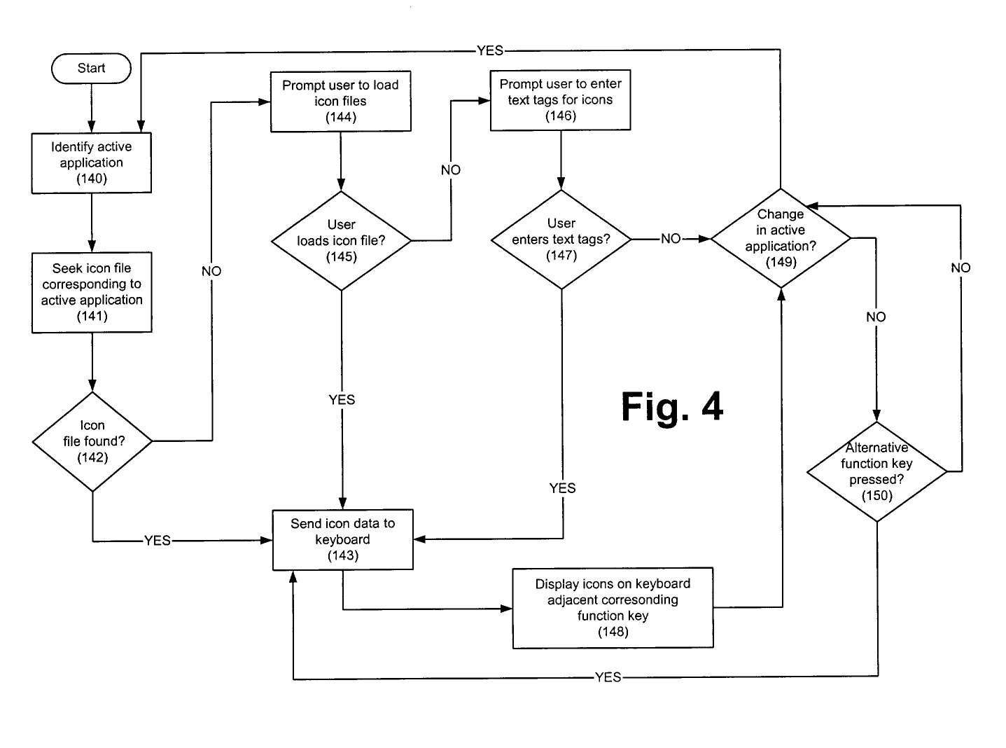

FIG. 4 is a flowchart illustrating a method according to principles of the present invention. The flowchart in FIG. 4 may be considered as illustrating the operation of the keyboard driver (132: FIG. 3). The flowchart of FIG. 4 would enable one of ordinary skill in the art to code an embodiment of the keyboard driver (132: FIG. 3) without undue experimentation.

As shown in FIG. 4, the method begins by identifying the active application (140). The icons that should be displayed in association with the function keys on the keyboard will depend entirely on which application is active on the computer system at any given time.

Next, the keyboard driver seeks an icon file that corresponds to the active application (141). The keyboard driver will preferably first seek for the icon file on the hard drive of its host computer or other drives of its host computer. If the icon file is not found there, the keyboard driver may be configured to search for the icon file on any other devices or drives networked to its host computer. This may include searching the Internet for the icon file, if the host computer is connected to the Internet. If an icon file is found (142), the icon data is retrieved and sent to the keyboard (143) so that appropriate icons can be displayed by the keyboard (148) in association with the function keys.

The display of these icons is maintained until the active application changes (149) or an alternative function key is pressed (150). If a new application is made the active application (149), the method starts over with the identification of the new active application (140) and a search for an icon file corresponding to that active application (141). If an alternative function key is pressed (150), such as the CTRL key, the SHIFT key or the ALT key, the keyboard driver will send a new set of icon data to the keyboard (143). This new set of icon data allows the display of icons that indicate the functions that will be invoked if a function key is pressed while the alternative function key or keys are concurrently held down. This new set of icons is then displayed (148) on the keyboard as long as the alternative function key or keys are depressed.

It may be the case that when the keyboard driver seeks to locate an icon file corresponding to the active application, that no such icon file will be found (142). If this is the case, the keyboard driver may prompt the user to load or locate the icon file for the active application (144). If the user has access to the icon file, the user may comply (145). If so, the icon data can then be sent to the keyboard and used to display icons (143) as described above. A user may, however, find this annoying. Therefore, the keyboard driver will preferably have the option of deactivating this prompt to load the icon file if an appropriate icon file is not found on the host computer or on any resources accessible to the host computer.

If the user cannot or does not load or identify the location of an appropriate icon file, the keyboard driver may prompt the user to create icons for the function keys or ask the user if he or she wishes to define labels for the function keys (146). This preferably entails the user entering a text tag that will be used as a textual icon to identify the function invoked by a particular function key. The user may enter such text tags (147) using, for example, reference material that lists the functions invoked by each function key or combination of a function key with one or more alternative function keys. Again, the user may wish to deactivate this prompt to enter text tags when an appropriate icon file is not located.

If the user enters text tags (147), the text tags may be saved as an icon file for the then-current application. Additionally, the text tags are sent as icon data to the keyboard (143) for display. If the user does not enter text tags (147), the keyboard driver cannot display any icons until the active application changes (149). The keyboard driver can then seek an icon file for the new active application and repeat the method.

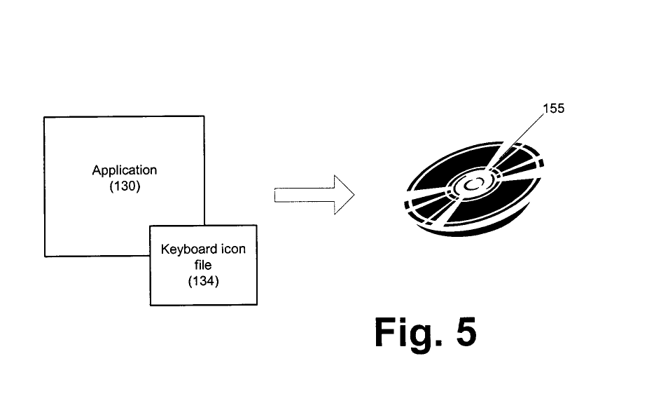

FIG. 5 illustrates a bundled application and keyboard icon file according to principles of the present invention. Given the advantages provided by the present invention, application developers will likely want to provide keyboard icon files with their applications. As described above, an icon file (e.g., 134) provides the icon data that the keyboard driver (132: FIG. 3) sends to the keyboard (100a: FIG. 3) to generate appropriate icons on the display devices (120; FIG. 2) of the keyboard (100a; FIG. 3). Each application can assign different functions to the various function keys and combinations of a function key with one or more alternative function keys.

Consequently, as shown in FIG. 5, each application (130) will likely require its own corresponding keyboard icon file (134) which provides appropriate icons for the functions assigned to the various function keys by that application (130). Application developers will, therefore, likely bundle a keyboard icon file (134) with the application (130) for sales and/or distribution.

The bundled application (130) and keyboard icon file (134) may be distributed via a network, for example, the Internet. Alternatively, as illustrated in FIG. 5, the bundled application (130) and keyboard icon file (134) may be recorded on a storage device such as an optical disc (155) for distribution. The storage device (e.g., 155) on which the bundled application (130) and keyboard icon file (134) are placed for distribution may be any data storage device now known or later developed.

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A system for identifying functions invoked by function keys on a keyboard, said system comprising:
a keyboard comprising;
a plurality of function keys, and
at least one display device, wherein said at least one display device is configured to display icons that correspond to said function keys and give an indication of a function invoked by each function key; and
a keyboard driver for transmitting icon data to said keyboard.

2. The system of claim 1, wherein said keyboard driver is running on a computer connected to said keyboard.

3. The system of claim 2, further comprising a Universal Serial Bus connecting said computer and said keyboard.

4. The system of claim 2, further comprising:
at least one application running on said computer; and
at least one icon file stored on said computer, said at least one icon file corresponding to an application running on said computer.

5. The system of claim 4, wherein said keyboard driver:
identifies an active application from among applications running on said computer;
identifies an icon file corresponding to said active application; and
transmits icon data to said keyboard from that identified icon file.

6. The system of claim 2, wherein:
said keyboard further comprises at least one alternative function key;
said keyboard driver sending a new set of icon data to said keyboard when an alternative function key is pressed.

7. The system of claim 1, wherein said at least one display device comprises a separate display device disposed in association with each function key.

8. The system of claim 1, wherein said at least one display device comprises a single display device disposed along said function keys.

9. A keyboard comprising;
a plurality of function keys, and
at least one display device, wherein said at least one display device is configured to display icons that correspond to said function keys and give an indication of a function invoked by each function key.

10. The system of claim 9, wherein said at least one display device comprises a separate display device disposed in association with each function key.

11. The system of claim 9, wherein said at least one display device comprises a single display device disposed along said function keys.

12. A bundle of software stored on a data storage medium, said bundle of software comprising:
an application; and
a keyboard icon file containing icons corresponding to functions assigned to function keys of a keyboard by said application.

13. The bundle of software of claim 12, wherein said data storage medium is an optical disc.

14. A method for identifying functions invoked by function keys on a keyboard, said method comprising displaying icons on a display device on said keyboard, said icons being associated respectively with said function keys and giving an indication of a function invoked by each respective function key.

15. The method of claim 14, further comprising driving said display device on said keyboard with a driver that is running on a computer connected to said keyboard.

16. The method of claim 15, further comprising connecting said computer and said keyboard with a Universal Serial Bus.

17. The method of claim 15, further comprising:
identifying an active application running on said computer;
accessing a keyboard icon file corresponding to said active application; and
transmitting icon data to said keyboard from said keyboard icon file.

18. The method of claim 14, further comprising:
pressing an alternative function key on said keyboard; and
displaying a new set of icons while said alternative function key is pressed.

19. The method of claim 15, further comprising:
detecting when an alternative function key on said keyboard is pressed;
accessing a keyboard icon file corresponding to an active application; and
transmitting a new set of icon data to said keyboard from said keyboard icon file.

20. The method of claim 15, further comprising:
detecting a change in active application on said computer;
accessing a keyboard icon file corresponding to a new active application; and
transmitting icon data to said keyboard from said keyboard icon file.

21. The method of claim 15, further comprising:
searching for a keyboard icon file corresponding to an active application on said computer; and
prompting a user to load said corresponding keyboard icon file if said searching fails.

22. The method of claim 15, further comprising:
searching for a keyboard icon file corresponding to an active application on said computer; and
prompting a user to enter icon data if said searching fails.
